(19) United States
(12) Patent Application Publication
(10) Pub. No.: US 2018/0300438 A1
(43) Pub. Date: Oct. 18, 2018

(54) DEVICE AND METHOD FOR GEOMETRICAL CONSTRUCTION OF PREDICTED VEHICLE OCCUPANCY AREA

(71) Applicant: Continental Automotive GmbH, Hannover (DE)

(72) Inventor: Denis Selensky, Frankfurt (DE)

(73) Assignee: Continental Automotive GmbH, Hannover (DE)

(21) Appl. No.: 15/949,216

(22) Filed: Apr. 10, 2018

(30) Foreign Application Priority Data
Apr. 12, 2017 (DE) 10 2017 206 345.9

(51) Int. Cl. G06F 17/50

(52) U.S. Cl. CPC G06F 17/5009; G05D 1/0212

(57) ABSTRACT

A trajectory allocator provides a vehicle trajectory based on a list of vehicle vertices each of which define a position and a moving direction of one point of an vehicle body. A trajectory transformer calculates a list of the extreme points vertices by selecting a point of the vehicle body with the smallest and/or the largest turning radius for a given position of the vehicle and provides multiple corner trajectories based on the list of extreme points vertices. A gap terminator and an intersection remover provide an occupancy corridor based on the multiple corner trajectories. The gap terminator connects consecutive arcs of the multiple corner trajectories. The intersection remover truncates intersecting arcs of the multiple corner trajectories.

### FIELD OF THE INVENTION

The present invention relates to the field of grid-based prediction of the position and occupancy area of an object. Particularly, the present invention relates to a device and a method for geometrical construction of predicted vehicle occupancy area.

### BACKGROUND OF THE INVENTION

When calculating and visualizing the predicted occupancy corridor of the vehicle with a complex arc-spline based trajectory, the vehicle's discrete pose along the trajectory is used to calculate sampling points, which are interpolated.

The corner points, i.e. any extreme points, of the vehicle are taken into account to calculate for any given position along the path of the corner, which stands out the most.

The discretization of the vehicle trajectory puts limits to the accuracy of the calculation. The vehicles corner points must be transformed at any discrete vehicle pose in order to obtain the position at the given point.

If demand for accuracy rises, the computation effort rises with the demanded accuracy, as more transformations are necessary.

### SUMMARY OF THE INVENTION

There may be a need to improve device and methods for calculating occupancy areas and corridors for a vehicle.

These needs are met by the subject-matter of the independent claims. Further exemplary embodiments are evident from the dependent claims and the following description.

An aspect of the present invention relates to a device for geometrical construction of predicted vehicle occupancy area, the device comprising: a trajectory allocator, which is configured to provide a vehicle trajectory based on a list of vehicle vertices each of which defining a position and a moving direction of one point of a vehicle body of a vehicle; a trajectory transformer, which is configured to calculate a list of the extreme points vertices by selecting a point of the vehicle body with the smallest and/or the largest turning radius for a given position of the vehicle and which is configured to provide multiple corner trajectories based on the list of extreme points vertices of the vehicle; and a gap terminator and an intersection remover, which are configured to provide an occupancy corridor based on the multiple corner trajectories, wherein the gap terminator is configured to connect consecutive arcs of the multiple corner trajectories and wherein the intersection remover is configured to truncate intersecting arcs of the multiple corner trajectories.

The present method solves the problem of calculating the occupancy corridor with discrete points by transforming the non-discrete arc trajectory of the vehicle. The trajectory of the corners are calculated as arcs themselves limiting the number of necessary transformations to a minimum.

The present method may be used as a method for geometrical construction of predicted vehicle occupancy area for visualization based on optimal arc spline approximation as well as spline-based trajectory optimization for autonomous vehicles with Ackerman drive or Ackermann steering geometry.

A further, second aspect of the present invention relates to a method for geometrical construction of predicted vehicle occupancy area, the method comprising the following steps of: providing a vehicle trajectory based on a list of vehicle vertices each of which defining a position and a moving direction of one point of an vehicle body of a vehicle by means of a trajectory allocator; calculating a list of the extreme points vertices by selecting a point of the vehicle body with the smallest and/or the largest turning radius for a given position of the vehicle by means of a trajectory transformer and providing multiple corner trajectories based on the list of extreme points vertices the vehicle by means of the trajectory transformer; providing an occupancy corridor based on the multiple corner trajectories by means of gap terminator and an intersection remover by connecting consecutive arcs of the multiple corner trajectories; and by truncating of intersecting arcs of the multiple corner trajectories.

According to an exemplary embodiment of the present invention,

the intersection remover is configured to truncate intersecting arcs of the multiple corner trajectories by truncation of the intersecting arcs at the intersection point keeping the part, which is directed outwards.

According to an exemplary embodiment of the present invention,

the trajectory transformer is configured to calculate the list of the extreme points vertices for all segments of the vehicle trajectory.

According to an exemplary embodiment of the present invention,

the trajectory allocator is configured to provide the vehicle trajectory as arc spline.

According to an exemplary embodiment of the present invention,

the gap terminator and the intersection remover are configured to provide the occupancy corridor based on at least two continuous curves based on the multiple corner trajectories.

A computer program performing the method of the present invention may be stored on a computer-readable medium. A computer-readable medium may be a floppy disk, a hard disk, a CD, a DVD, an USB (Universal Serial Bus) storage device, a RAM (Random Access Memory), a ROM (Read Only Memory) or an EPROM (Erasable Programmable Read Only Memory).

A computer-readable medium may also be a data communication network, for example the Internet, which allows downloading a program code.

The methods, systems, and devices described herein may be implemented as software in a Digital Signal Processor, DSP, in a micro-controller or in any other side-processor or as a hardware circuit within an application specific integrated circuit, ASIC, CPLD or FPGA.

The present invention can be implemented in digital electronic circuitry or in computer hardware, firmware, software, or in combinations thereof, for instance in available hardware of conventional medical imaging devices or in new hardware dedicated for processing the methods described herein.

### BRIEF DESCRIPTION OF THE DRAWINGS

A more complete appreciation of the invention and the attendant advantages thereof will be clearly understood by reference to the following schematic drawings, which are not to scale, wherein:

FIG. 1 shows a vehicle trajectory given as arc spline according to an exemplary embodiment of the present invention;

FIG. 2 shows a non-discrete transformation of corner points according to an exemplary embodiment of the present invention;

FIG. 3 shows the proposed approach of a transformation applied to all segments of the vehicle trajectory according to an exemplary embodiment of the present invention;

FIG. 4 shows the proposed approach according to which intersections and gaps resolved: a continuous, uninterrupted curve as a result is provided according to an exemplary embodiment of the present invention;

FIG. 5 shows a schematic diagram of the device for geometrical construction of predicted vehicle occupancy area according to an exemplary embodiment of the present invention;

FIG. 6 shows a schematic flowchart diagram of the method for geometrical construction of predicted vehicle occupancy area according to an exemplary embodiment of the present invention; and

FIG. 7 shows a sketch of one possible visualization of the calculated corridor as used in the surround view project.

### DETAILED DESCRIPTION

The illustration in the drawings is purely schematic and does not intend to provide scaling relations or size information. In different drawings, similar or identical elements are provided with the same reference numerals.

Generally, identical parts, units, entities or steps are provided with the same reference symbols in the description.

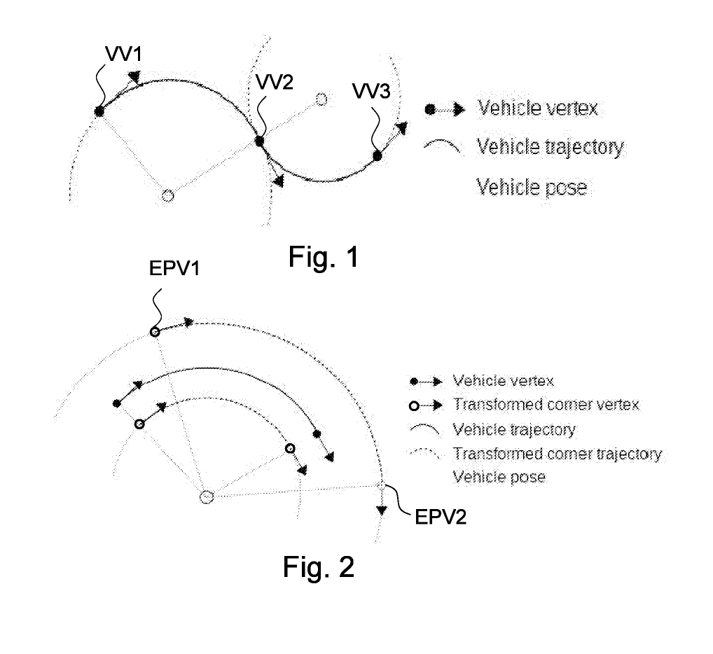

FIG. 1 shows a vehicle trajectory given as arc spline according to an exemplary embodiment of the present invention.

FIG. 2 shows a non-discrete transformation of corner points according to an exemplary embodiment of the present invention.

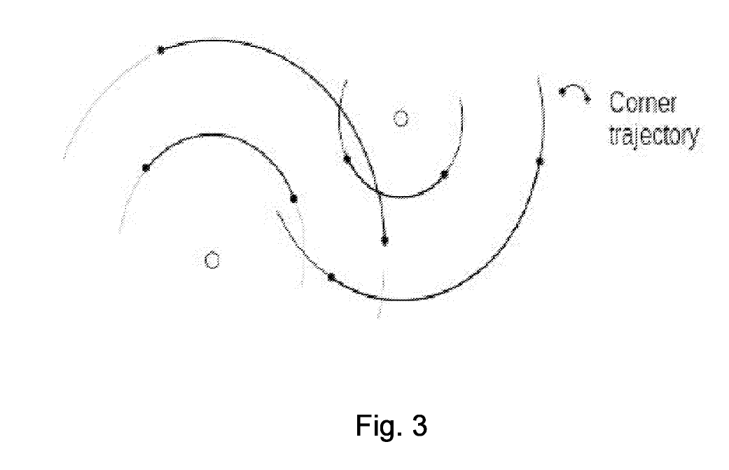

FIG. 3 shows the proposed approach of a transformation applied to all segments of the vehicle trajectory according to an exemplary embodiment of the present invention.

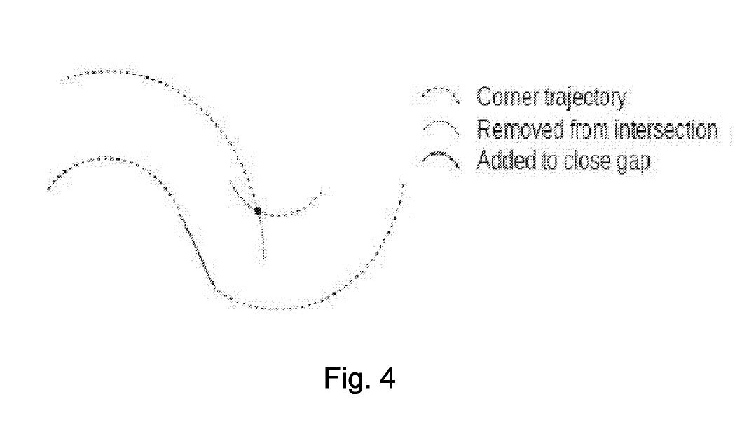

FIG. 4 shows the proposed approach according to which intersections and gaps resolved: a continuous, uninterrupted curve as a result is provided according to a further exemplary embodiment of the present invention.

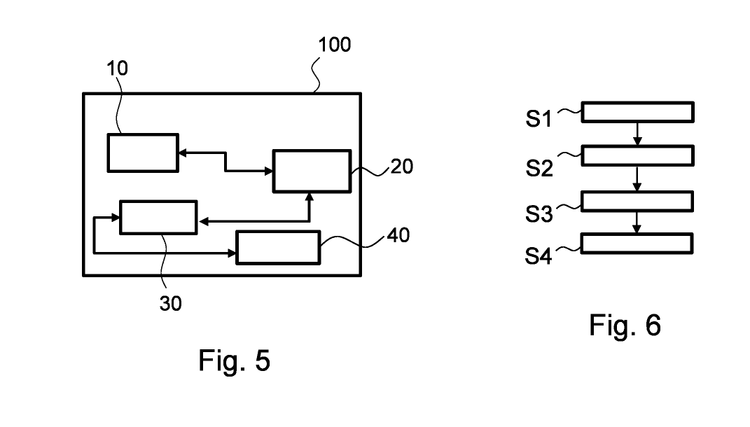

FIG. 5 shows a schematic diagram of the device for geometrical construction of predicted vehicle occupancy area according to an exemplary embodiment of the present invention.

The device 100 for geometrical construction of predicted vehicle occupancy area comprises a trajectory allocator 10, a trajectory transformer 20, a gap terminator 30, and an intersection remover 40.

The trajectory allocator 10 is configured to provide a vehicle trajectory based on a list of vehicle vertices VV1, VV2, VV3, . . . , VVn each of which defining a position and a moving direction of one point VBP of an vehicle body VB of a vehicle V.

The trajectory allocator 10 may be configured to receive the list of vehicle vertices VV1, VV2, VV3, . . . , VVn from external devices or providers. The trajectory allocator 10 may comprise a interface or a communication system in order to receive data in terms of the list of vehicle vertices.

The trajectory transformer 20 is configured to calculate a list of the extreme points vertices EPV1, EPV2, EPV3, . . . , EPVn by selecting a point VBP of the vehicle body VB with the smallest and/or the largest turning radius for a given position of the vehicle and which is configured to provide multiple corner trajectories based on the list of extreme points vertices EPV1, EPV2, EPV3, . . . , EPVn of the vehicle V.

The gap terminator 30 and the intersection remover 40 are configured to provide an occupancy corridor based on the multiple corner trajectories, wherein the gap terminator 30 is configured to connect consecutive arcs of the multiple corner trajectories and wherein the intersection remover 40 is configured to truncate intersecting arcs of the multiple corner trajectories.

FIG. 6 shows a schematic diagram of the method for geometrical construction of predicted vehicle occupancy area according to an exemplary embodiment of the present invention.

The method for geometrical construction of predicted vehicle occupancy area comprises the following steps:

As a first step of the method, providing S1 a vehicle trajectory based on a list of vehicle vertices VV1, VV2, VV3, . . . , VVn may be performed, each of which defining a position and a moving direction of one point VBP of an vehicle body VB of a vehicle V by means of a trajectory allocator 10.

As a second step of the method, calculating S2 a list of the extreme points vertices EPV1, EPV2, EPV3, . . . , EPVn by selecting a point VBP of the vehicle body VB with the smallest and/or the largest turning radius for a given position of the vehicle by means of a trajectory transformer 20 may be performed.

Further providing multiple corner trajectories based on the list of extreme points vertices EPV1, EPV2, EPV3, . . . , EPVn of the vehicle V by means of the trajectory transformer 20 may be performed.

Further, providing an occupancy corridor based on the multiple corner trajectories by means of a gap terminator 30 and by means of an intersection remover 40 may be performed.

As a third step of the method, connecting S3 consecutive arcs of the multiple corner trajectories may be performed.

As a fourth step of the method, truncating S4 of intersecting arcs of the multiple corner trajectories may be performed.

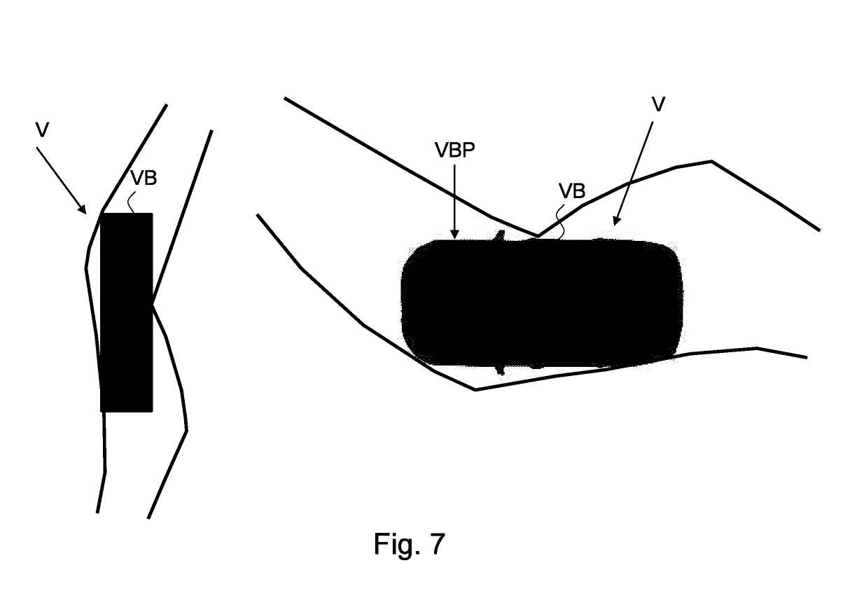

FIG. 7 shows a sketch of one possible visualization of the calculated corridor as used in the surround view project. The trajectory, which is taken as a basis, is taken from a real parking situation.

FIG. 7 shows a moving direction of one point VBP—e.g. a certain point of the vehicle point, for instance the top of the right wing of—an vehicle body VB of a vehicle V.

It has to be noted that embodiments of the present invention are described with reference to different subject-matters. In particular, some embodiments are described with reference to method type claims, whereas other embodiments are described with reference to the device type claims.

However, a person skilled in the art will gather from the above and the foregoing description that, unless otherwise notified, in addition to any combination of features belonging to one type of the subject-matter also any combination between features relating to different subject-matters is considered to be disclosed with this application.

However, all features can be combined providing synergetic effects that are more than the simple summation of these features.

While the invention has been illustrated and described in detail in the drawings and foregoing description, such illustration and description are to be considered illustrative or exemplary and not restrictive; the present invention is not limited to the disclosed embodiments.

Other variations to the disclosed embodiments can be understood and effected by those skilled in the art and practicing the claimed invention, from a study of the drawings, the disclosure, and the appended claims.

In the claims, the word “comprising” does not exclude other elements or steps, and the indefinite article “a” or “an” does not exclude a plurality. A single processor or controller or other unit may fulfill the functions of several items recited in the claims.

The mere fact that certain measures are recited in mutually different dependent claims does not indicate that a combination of these measures cannot be used to advantage. Any reference signs in the claims should not be considered as limiting the scope.

1. An apparatus for geometrical construction of predicted vehicle occupancy area, the apparatus comprising:
a trajectory allocator, configured to provide a vehicle trajectory based on a list of vehicle vertices each of which defines a position and a moving direction of one point of a vehicle body of a vehicle;
a trajectory transformer, configured to calculate a list of the extreme points vertices by selecting a point of the vehicle body with the smallest and/or the largest turning radius for a given position of the vehicle and which is configured to provide multiple corner trajectories based on the list of extreme points vertices of the vehicle; and
a gap terminator and an intersection remover, which are configured to provide an occupancy corridor based on the multiple corner trajectories, wherein the gap terminator is configured to connect consecutive arcs of the multiple corner trajectories and wherein the intersection remover is configured to truncate intersecting arcs of the multiple corner trajectories.

2. The apparatus of claim 1, wherein the intersection remover is configured to truncate intersecting arcs of the multiple corner trajectories by truncation of the intersecting arcs at the intersection point keeping the part, which is directed outwards.

3. The apparatus of claim 2, wherein the trajectory transformer is configured to calculate the list of the extreme points of vertices for all segments of the vehicle trajectory.

4. The apparatus of claim 3, wherein the trajectory allocator is configured to provide the vehicle trajectory as arc spline.

5. The apparatus of claim 4, wherein the gap terminator and the intersection remover are configured to provide the occupancy corridor based on at least two continuous curves based on the multiple corner trajectories.

6. A method for geometrical construction of predicted vehicle occupancy area, the method comprising:
providing a vehicle trajectory based on a list of vehicle vertices, each of which define a position and a moving direction of one point of a vehicle body of a vehicle by a trajectory allocator;
calculating a list of the extreme points vertices by selecting a point of the vehicle body with the smallest and/or the largest turning radius for a given position of the vehicle by means of a trajectory transformer and providing multiple corner trajectories based on the list of extreme points vertices of the vehicle by the trajectory transformer;
providing an occupancy corridor based on the multiple corner trajectories by means of gap terminator and an intersection remover by connecting consecutive arcs of the multiple corner trajectories and by truncating of intersecting arcs of the multiple corner trajectories.

7. The method of claim 6, further comprising: truncating intersecting arcs of the multiple corner trajectories by truncation of the intersecting arcs at the intersection point keeping the part, which is directed outwards.

8. The method of claim 7, further comprising: calculating the list of the extreme points vertices for all segments of the vehicle trajectory.

9. The method of claim 8, further comprising: calculating the vehicle trajectory as arc spline.
